(19) United States
(12) Patent Application Publication
(10) Pub. No.: US 2019/0377230 A1
(43) Pub. Date: Dec. 12, 2019

(54) LCD DEVICE WITH SELF-COMPENSATED ELECTRODE PATTERNS

(71) Applicant: VastView Technology Inc., Hsinchu County (TW)

(72) Inventors: Cheng Chung Peng, Hsinchu County (TW); Yuhren Shen, Hsinchu County (TW)

(21) Appl. No.: 16/102,771

(22) Filed: Aug. 14, 2018

Related U.S. Application Data
(63) Continuation-in-part of application No. 16/004,345, filed on Jun. 9, 2018.

(51) Int. Cl. G02F 1/1343

(52) U.S. Cl. CPC G02F 1/134309; G02F 2001/134345

(57) ABSTRACT

An LCD device includes self-compensated ITO patterns. Each pixel area of the LCD device comprises at least one sub-pixel area formed with a self-compensated electrode pattern. At least an even number of slits are formed on the electrode pattern. Each slit may be parallel with or has an angle in the longitudinal direction with respect to the data line of the pixel area. Each pixel area may also comprise two sub-pixel areas and each sub-pixel area is formed with a self-compensated electrode pattern having at least an even number of slits. The self-compensated electrode pattern in one sub-pixel area may be identical or different from that of the other sub-pixel area.

### CROSS REFERENCE TO RELATED APPLICATIONS

This application is a continuation-in-part of U.S. patent application Ser. No. 16/004,345, filed on Jun. 9, 2018, which is incorporated herewith by reference in its entirety.

### BACKGROUND OF THE INVENTION

### 1. Field of the Invention

The present invention relates generally to a liquid crystal display (LCD) device, and more particularly to an LCD device with self-compensated indium tin oxide (ITO) or indium zinc oxide (IZO) electrode patterns for improving the display quality of the LCD device.

### 2. Description of Related Arts

An LCD device controls the light transmittance by using the characteristic that liquid crystal (LC) molecules present different light polarization or refraction effects under different alignments so as to produce images. A twisted nematic (TN) LCD device has good light transmittance but an extremely narrow viewing angle as influenced by the structure and optical characteristic of the LC molecules.

To solve the transmittance and viewing angle problems, a twisted vertical alignment model has been proposed so as to provide the high transmittance and the wide viewing angle. However, because the LC molecules are aligned in a vertical alignment manner, when the LC molecules are applied with a low voltage and the LCD device is watched at an inclined viewing angle, a gray-level inversion problem occurs, which causes the problem of color shift at an inclined viewing angle and influences a normal presentation of images of the LCD device.

To resolve this issue, two or more alignment domains are formed in the same pixel to form multi-domain vertical alignment (MVA) LCD device so as to eliminate the gray-level inversion problem and increase the viewing angles. In practice, three specific methods are provided. In the first method, one pixel is divided into multiple sub-pixel areas, and every sub-pixel area forms a different voltage by means of capacitive coupling, thereby producing the alignment effect of multiple sub-pixel areas. In the second method, one pixel is divided into multiple sub-pixel areas and two thin film transistors are used to make each sub-pixel area form a different voltage, thereby solving the gray-level inversion problem. In the third method, the pixel is divided into two or more sub-pixel areas and an electronic barrier material is covered above a part of the electrode of the sub-pixel area, thereby producing the alignment effect of multiple sub-pixel areas.

However, the methods for solving the above mentioned problem in the prior arts have complicated LCD device processes. In view of the above, it is the object of the present invention to provide a simple electrode structure for driving the LCD device with a wider viewing angle so that the LCD device can present optimal display quality.

### SUMMARY OF THE INVENTION

The present invention has been made to provide an LCD device with improved display quality in wide viewing angles. In order to compensate for the characteristics of the voltage-dependent normalized transmittance (V-T) curve at the off-axis viewing direction of the LCD device, self-compensated electrode patterns are provided in each pixel area of the LCD device to widen the viewing angles.

In one preferred embodiment, in each pixel area of the LCD device, there are at least two sub-pixel areas formed with different ITO or IZO electrode patterns. Each sub-pixel area of the pixel area comprises at least two electrodes. Each electrode is a solid electrode having a filled polygon shape. In other words, the polygon-shaped electrode has no void inside the electrode. The two solid electrodes in the sub-pixel area are electrically connected.

In one example of the present invention, the two solid electrodes in each sub-pixel area are connected by an electrode segment in the same electrode layer where the two solid electrodes are formed. In the other example, the two solid electrodes in each sub-pixel area are connected by a connection layer different from the electrode layer where the two solid electrodes are formed.

In accordance with one embodiment of the present invention, the electrode pattern in the sub-pixel area may be formed by removing selected regions in the same electrode layer so as to form an electrode segment and two slits on the two sides of the electrode segment that connects the two electrodes. As a result, the entire electrode pattern is either [symbol] -shaped or H-shaped.

According to the present invention, the dimensions of the solid electrodes in each sub-pixel area are designed in such a way so as to compensate for the characteristics of the V-T curve at the off-axis viewing direction of the LCD device. If the solid electrode in one sub-pixel area is designed with a larger size in a lateral direction than in a longitudinal direction, a corresponding solid electrode in one other sub-pixel area is designed with a smaller size in the lateral direction than in the longitudinal direction.

In another preferred embodiment of the present invention, each pixel area of the LCD device comprises one sub-pixel area formed with a self-compensated electrode pattern. The electrode pattern is neither left-right symmetric nor top-down symmetric. At least an even number of slits are formed on the electrode.

In an example of a preferred embodiment, there are two slits formed in the electrode of the sub-pixel area. One of the two slits has its majority portion located in an upper-left region of the sub-pixel area and the other of the two slits has its majority portion located in a lower-right region of the sub-pixel area.

In another example of a preferred embodiment, one of the two slits has its majority portion located in an upper-right region of the sub-pixel area and the other of the two slits has its majority portion located in a lower-left region of the sub-pixel area.

According to the present invention, the longitudinal direction of each slit may form an angle between 0 to 10 degrees to the data line in the pixel area, and preferably each slit is in parallel with the data line. The angle may also be between 15 to 30 degrees to the data line and preferably between 20 to 26 degrees. The slits may or may not be aligned on a same line in the pixel area.

Each slit in the sub-pixel area may have an open end in its longitudinal direction and the electrode in the sub-pixel area has a perimeter with intrusion formed by the slit. Each slit may also have no open end in its longitudinal direction and the electrode has a closed perimeter without any intrusion.

In a further embodiment of the present invention, each pixel area of the LCD device comprises two sub-pixel areas, each sub-pixel area being formed with a self-compensated electrode pattern. The electrode pattern in each sub-pixel area is neither left-right symmetric nor top-down symmetric. At least an even number of slits are formed on the electrode.

In an example of a preferred embodiment, the two sub-pixel areas have identical electrode patterns. The electrode in each sub-pixel area is formed with two slits. One of the two slits has its majority portion located in an upper-left region of the sub-pixel area and the other of the two slits has its majority portion located in a lower-right region of the sub-pixel area.

In another example of a preferred embodiment, the two sub-pixel areas have different electrode patterns. The electrode in each sub-pixel area is formed with two slits. In one sub-pixel area, the majority portions of the two slits are located respectively in the upper-left and lower-right regions of the sub-pixel area. In the other sub-pixel area, the majority portions of the two slits are located respectively in the upper-right and lower-left regions of the sub-pixel area.

In a further example of a preferred embodiment, the two sub-pixel areas also have different electrode patterns. The electrode in one sub-pixel area is formed with two slits having majority portions located respectively in the upper-left and lower-right regions of the sub-pixel area. The electrode in the other sub-pixel area is formed with four slits, two of the four slits have majority portions located respectively in the upper-right and lower-left regions, and the other two of the four slits have majority portions located respectively in the upper-left and lower-right regions of the sub-pixel area.

### BRIEF DESCRIPTION OF THE DRAWINGS

The present invention will be apparent to those skilled in the art by reading the following detailed description of preferred embodiments thereof, with reference to the attached drawing, in which:

FIG. 1 shows a cross sectional view of an LCD device according to the present invention.

FIG. 2 shows an example of the self-compensated electrode patterns formed in two sub-pixel areas of a pixel area in an LCD device according to the present invention.

FIG. 3 shows another example of the self-compensated electrode patterns formed in two sub-pixel areas of a pixel area in an LCD device according to the present invention.

FIG. 4 shows an example of a self-compensated electrode pattern formed in one sub-pixel area of a pixel area in an LCD device according to the present invention.

FIG. 5 shows a variation of the self-compensated electrode pattern shown in FIG. 4 with the opening ends of the two slits being closed.

FIG. 6 shows a variation of the self-compensated electrode pattern shown in FIG. 5 with the majorities of the two slits being respectively formed in the upper-right and lower-left regions of a pixel area to form an angle between 15 to 30 degrees with respect to the data line.

FIG. 7 shows another variation of the self-compensated electrode pattern shown in FIG. 5 with the majorities of the two slits being respectively formed in the upper-left and lower-right regions of a pixel area to form an angle between 15 to 30 degrees with respect to the data line.

FIG. 8 shows an example of two self-compensated electrode patterns shown in FIG. 5 respectively formed in two sub-pixel areas of a pixel area in an LCD device according to the present invention.

FIG. 9 shows an example of two self-compensated electrode patterns respectively formed in two sub-pixel areas of a pixel area in an LCD device with one electrode pattern being similar to that shown in FIG. 7 and the other electrode pattern being similar to that shown in FIG. 6.

FIG. 10 shows an example of two self-compensated electrode patterns respectively formed in two sub-pixel areas of a pixel area in an LCD device with one electrode pattern being similar to that shown in FIG. 7 and the other electrode pattern having four slits.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

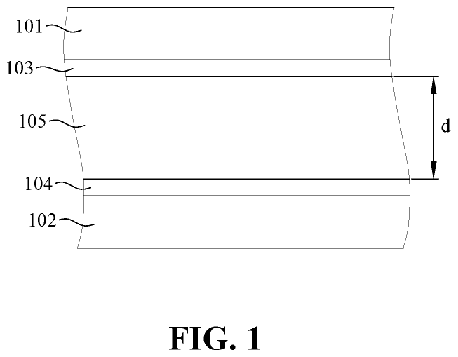

With reference to FIG. 1, an LCD device according to the present invention comprises a first substrate 101, a second substrate 102, a first electrode layer 103, a second electrode layer 104 and a liquid crystal layer 105 between the first and second electrode layers. The first and second substrates are opposite to each other and the liquid crystal layer 105 is disposed between the two substrates. The first and second electrode layers are formed on the first and second substrates respectively by a transparent conductive film such as ITO or IZO.

The liquid crystal molecules in the liquid crystal layer comprise a nematic liquid crystal material such as a nematic liquid crystal material with negative dielectric anisotropy. Substance having optical chirality is added in the liquid crystal layer. For example, an optically chiral dopant is added to the liquid crystal layer so that the liquid crystal molecules are twisted along an axis to result in optical chirality. The substance having optical chirality may have left or right twisting chirality. In order for the liquid crystal molecules to have enough space for twisting, it is preferred that the ratio of the thickness d of the liquid crystal layer to the pitch p of the optically chiral substance is between 0.16 and 0.42.

According to one embodiment of the present invention, each pixel area of the LCD device with self-compensated electrode patterns includes at least two sub-pixel areas and each sub-pixel area includes at least two electrically connected electrodes. The electrodes of each pixel area are solid electrodes. Each electrode is polygon shaped without any void inside the electrode. The polygon can be a triangle, a quadrilateral, a pentagon, or a hexagon. A preferred embodiment is that each sub-pixel region has only two electrodes, and each electrode is a solid polygonal electrode.

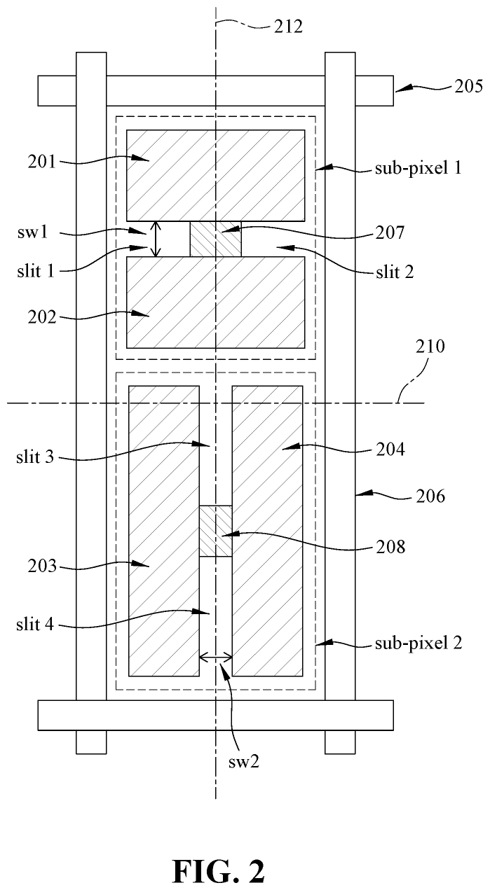

FIG. 2 shows an example of the self-compensated electrode patterns in a pixel area of an LCD device according to the present invention. The pixel area is defined by the gate line 205 and the data line 206 of the LCD device. Each pixel area comprises sub-pixel 1 and sub-pixel 2. Preferably, the ratio of the size of the sub-pixel 1 area to the size of the sub-pixel 2 area is between ⅓ and ¾.

In the area of sub-pixel 1, there are electrode 201 and electrode 202 electrically connected. Similarly, in the area of sub-pixel 2, there are electrode 203 and electrode 204 electrically connected. A vertical reference line 212 passing through the center of the pixel area is parallel to the data line 206 and a horizontal reference line 210 passing through the center of the pixel area is parallel to the gate line 205.

In order to improve the off-axis display quality under wider viewing angles, the electrode patterns in the two sub-pixel areas are designed to compensate for the characteristics of the off-axis V-T curve of the LCD device. For example, if the solid electrode 201 or 202 in sub-pixel 1 is designed with at least one larger size in a lateral direction than in a longitudinal direction, the corresponding solid electrode 203 or 204 in sub-pixel 2 should be designed with at least one smaller size in the lateral direction than in the longitudinal direction.

To the contrary, if the solid electrode 201 or 202 in sub-pixel 1 is designed with at least one smaller size in the lateral direction than in the longitudinal direction, the corresponding solid electrode 203 or 204 in sub-pixel 2 should be designed with at least one larger size in the lateral direction than in the longitudinal direction.

The solid electrode 201 or 202 has at least one smaller size in the longitudinal direction than the size of the solid electrode 203 or 204 in the longitudinal direction. The solid electrode 201 or 202 has at least one larger size in the lateral direction than the size of the solid electrode 203 or 204 in the lateral direction.

According to the characteristics of the off-axis V-T curve, if sub-pixel 1 has a better display quality than sub-pixel 2 at off-axis (θ,φ)=(60, 0) viewing angle, sub-pixel 2 would have a better display quality than sub-pixel 1 at off-axis (θ,φ)=(60, 90) viewing angle, where θ and φ are symbols for polar and azimuth angles. As a result, the solid electrodes designed with complimentary dimensions in the two sub-pixel areas as described above can compensate for each other to improve the off-axis display quality of the LCD device.

In a preferred embodiment as shown in FIG. 2, there are two sub-pixel areas in each pixel area. Electrode 201 in sub-pixel 1 has the same shape as electrode 202 in sub-pixel 1, and electrode 203 in sub-pixel 2 has the same shape as electrode 204 in sub-pixel 2. The electrodes in the pixel area are all rectangular shaped solid electrodes. It should be noted that electrodes 201 and 202 in sub-pixel 1 are electrically connected by an electrode segment in the same electrode layer as electrodes 201 and 202 in sub-pixel 1. Electrodes 203 and 204 in sub-pixel 2 are also electrically connected by an electrode segment in the same electrode layer as electrodes 203 and 204.

As shown in FIG. 2, electrodes 201 and 202 in sub-pixel 1 each have a horizontal length greater than the vertical length, and electrodes 203 and 204 in sub-pixel 2 each have a horizontal length smaller than the vertical length. The entire electrode pattern of sub-pixel 1 may be [symbol] -shaped and made by removing selected electrode regions in the electrode layer to form an electrode segment 207 and two slits, i.e., slit 1 and slit 2, with slit width swl between electrode 201 and electrode 202.

In the example shown in FIG. 2, two selected electrode regions in sub-pixel 1 are removed, i.e., at least an even number of electrode regions are removed to form an electrode pattern with an even number of slits. The electrode pattern in sub-pixel 1 is left-right symmetrical with respect to the vertical reference line 212.

Similarly, the entire electrode pattern of sub-pixel 2 may be H-shaped and made by removing selected regions in the electrode layer to form an electrode segment 208 and two slits, i.e., slit 3 and slit 4, with slit width sw2 between electrode 203 and electrode 204. Preferably, sw1 is less or equal to sw2. In this example, the slits in sub-pixel 1 or sub-pixel 2 may be formed on the same line or different line. In other words, the two slits in a sub-pixel may have a positional difference. The slit width may also be non-uniform with slit width getting narrower in area closer to the center of the sub-pixel.

In some variation, each pixel area of the LCD device of the present invention may have one sub-pixel area, i.e., sub-pixel 1 or sub-pixel 2. Under this situation, the electrode pattern in the sub-pixel area is left-right symmetric with respect to the vertical reference line. The electrode pattern in the sub-pixel area is also top-bottom symmetric with respect to horizontal reference line that passes through the center of the sub-pixel area.

With reference to FIG. 2, the two slits with width swl in sub-pixel 1 are parallel to the horizontal reference line 210. In the present invention, it is preferred that the width sw1 is greater than half of the thickness d of the liquid crystal layer but less than twice of the thickness d, i.e., 0.5 d<sw1<2 d. The two slits with width sw2 are parallel to the vertical reference line 212. The width sw2 should be greater than half of the thickness d and less than twice of the thickness d, preferably 1.5 d<sw2<2 d. For each slit with length L and width W, L should be greater than W, and preferably L>1.5 W.

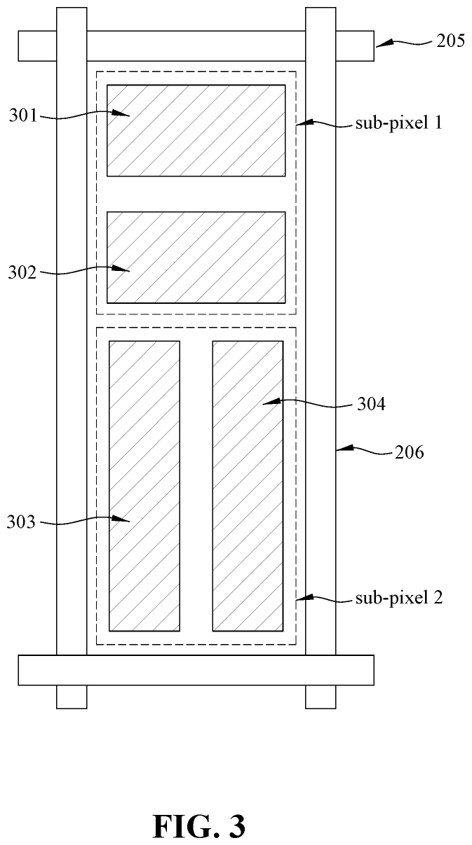

FIG. 3 shows another example of the self-compensated electrode patterns in a pixel area of an LCD device according to the present invention. In this example, each pixel area defined by the gate line 205 and the data line 206 also comprises sub-pixel 1 and sub-pixel 2. In the area of sub-pixel 1, there are also two electrodes 301 and 302. Similarly, in the area of sub-pixel 2, there are two electrodes 303 and 304.

As shown in FIG. 3, the electrodes in the pixel area are all rectangular shaped with the electrode structure and size similar to those in FIG. 2. However, the electrodes 301 and 302 in sub-pixel 1 are electrically connected in a layer different from the electrode layer of electrodes 301 and 302. The electrodes 303 and 304 are also electrically connected in a layer different from the electrode layer of electrodes 303 and 304.

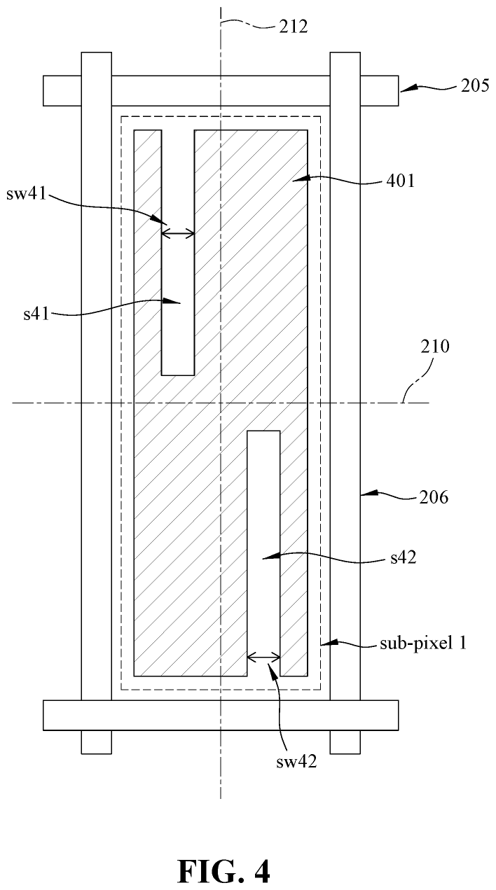

FIG. 4 shows an example of a self-compensated electrode pattern 401 in a pixel area of an LCD device according to another preferred embodiment of the present invention. The pixel area is defined by the gate line 205 and the data line 206 of the LCD device. In this embodiment, each pixel area comprises only one sub-pixel area, i.e., sub-pixel 1. The electrode pattern 401 is formed by removing two selected regions in the electrode layer in the sub-pixel area to form an electrode pattern 401 that is non-symmetric in both left-right and top-down directions.

As shown in FIG. 4, in the pixel area, a vertical reference line 212 passing through the center of the pixel area is parallel to the data line 206 and a horizontal reference line 210 passing through the center of the pixel area is parallel to the gate line 205. The electrode pattern 401 is neither left-right symmetric with respect to the vertical reference line 212 nor top-down symmetric with respect to the horizontal reference line 210.

The two selected electrode regions that have been removed in the pixel area form two slits, i.e., slit s41 and slit s42, with width sw41 and sw42 respectively as shown in FIG. 4. The longitudinal direction of each slit and data line 206 has an angle between 0 to 10 degrees. Preferably, the angle is 0 degree as shown in FIG. 4. It is preferred that the angle between slit s41 and data line 206 is the same as the angle between slit s42 and data line 206. However, the two angles may also be different.

In a preferred embodiment of the example shown in FIG. 4, both slits are parallel to the vertical reference line 212. Widths sw41 and sw42 may be identical or different. Both of them are greater than the thickness d of the liquid crystal layer, preferably 1.5 d<sw41<2 d and 1.5 d<sw42<2 d.

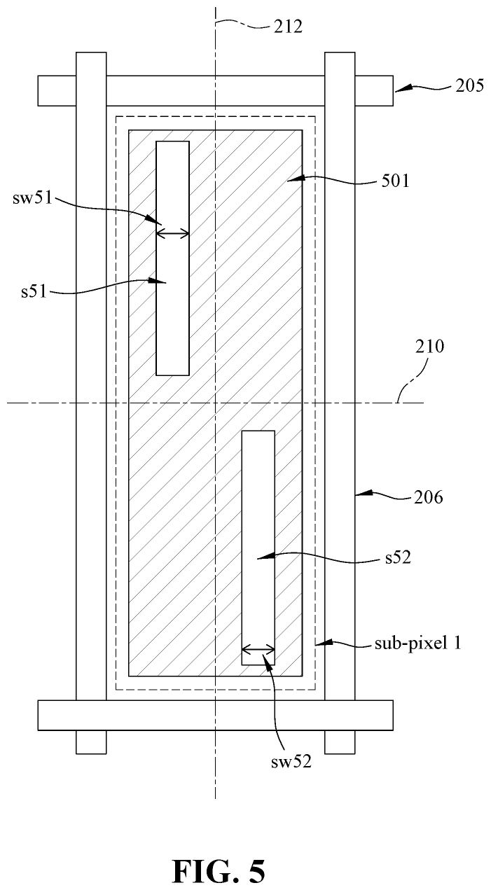

FIG. 5 shows another example of a self-compensated electrode pattern 501 in a pixel area of an LCD device according to the present invention. The electrode pattern 501 in this example is similar to that shown in FIG. 4 except that the two slits s51 and s52 have no opening ends. In other words, the electrode pattern 501 has a closed perimeter without any intrusion.

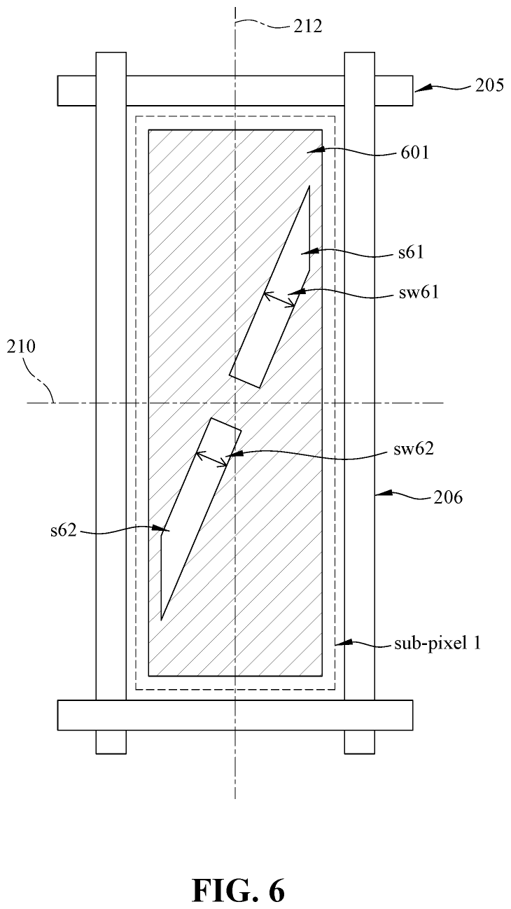

FIG. 6 shows a variation of the self-compensated electrode pattern in a pixel area of an LCD device shown in FIG. 5. In this example, the two slits s61 and s62 in the electrode pattern 601 also have no opening ends and the electrode pattern 601 has a closed perimeter without any intrusion similar to FIG. 5. However, the two slits s61 and s62 are not parallel to the vertical reference line 212. The longitudinal direction of each slit and data line 206 form an angle between 15 to 30 degrees. Preferably, the angle is between 20 to 26 degrees.

As shown in FIG. 6, the pixel area has upper-right, lower-right, upper-left and lower-left regions divided by the vertical and horizontal reference lines 212, 210. It can be seen that the majority portion of slit s61 is located in the upper-right region and the majority of slit s62 is located in the lower-left region. In the example shown in FIG. 6, the angle between slit s61 and data line 206 is the same as the angle between slit s62 and data line 206. The two slits s61 and s62 are located on the same line. However, it is not necessary that the two slits have to be located or aligned on the same line.

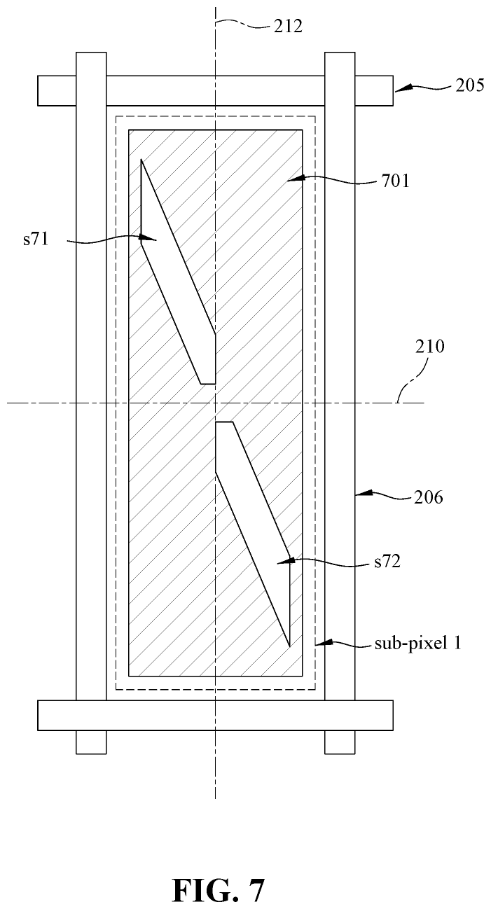

FIG. 7 shows another variation of the self-compensated electrode pattern in a pixel area of an LCD device shown in FIG. 5. In this example, the two slits s71 and s72 in the electrode pattern 701 also have no opening ends and the electrode pattern 701 has a closed perimeter without any intrusion similar to FIG. 5. Similar to FIG. 6, the two slits s71 and s72 are not parallel to the vertical reference line 212 either. However, the majority portion of slit s71 is located in the upper-left region of the pixel area and the majority of slit s72 is located in the lower-right region.

In the example shown in FIG. 7, the longitudinal direction of each slit and data line 206 also form an angle between 15 to 30 degrees. Preferably, the angle is between 20 to 26 degrees. The angle between slit s71 and data line 206 can be the same as the angle between slit s72 and data line 206. The two slits s71 and s72 are misaligned on the same line. However, it is not necessary for the two slits to be located or aligned on the different location. The two slits may be located on the same line.

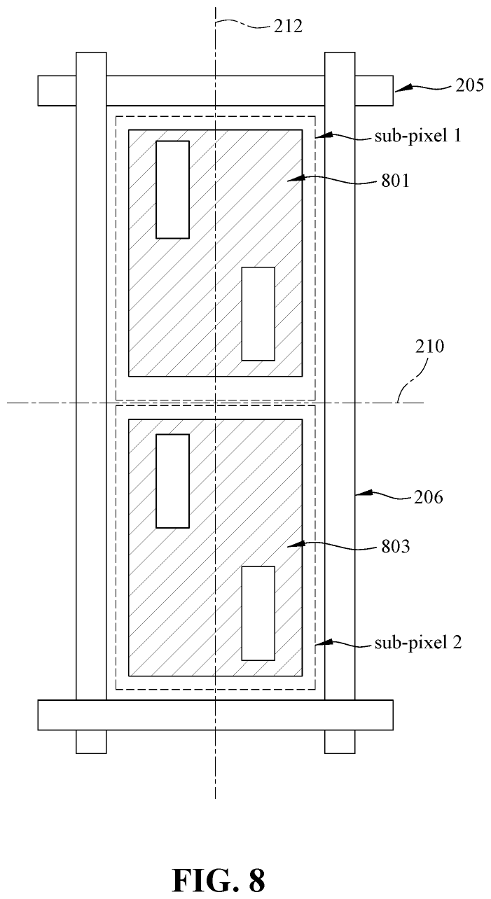

FIG. 8 shows an alternative example of the self-compensated electrode patterns in a pixel area of an LCD device according to another embodiment of the present invention. In this embodiment, each pixel area comprises sub-pixel 1 and sub-pixel 2. Each sub-pixel area is formed with a self-compensated electrode pattern similar to the one shown in FIG. 5. As shown in FIG. 8, the two sub-pixels have identical electrode patterns 801 and 803.

As shown in FIG. 8, the electrode pattern 801 or 803 in each sub-pixel area is formed with two slits. One of the two slits has its majority portion located in an upper-left region of the sub-pixel area and the other of the two slits has its majority portion located in a lower-right region of the sub-pixel area. The longitudinal direction of each slit may form an angle between 0 to 10 degrees to the data line 206 in the pixel area, and preferably each slit is in parallel with the data line 206.

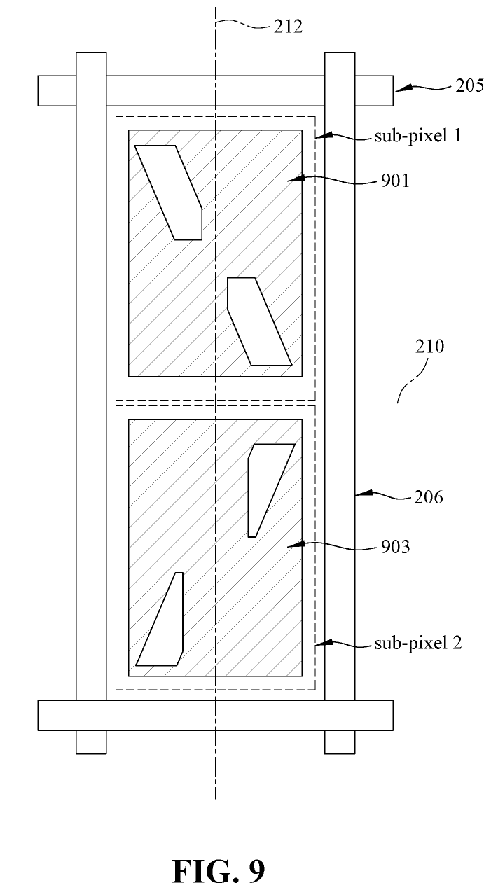

FIG. 9 shows a variation of FIG. 8 for the self-compensated electrode patterns in a pixel area of an LCD device according to the present invention. In this example, each pixel area also comprises sub-pixel 1 and sub-pixel 2. Sub-pixel 1 is formed with a self-compensated electrode pattern 901 similar to the one shown in FIG. 7 and sub-pixel 2 is formed with a self-compensated electrode pattern 903 similar to the one shown in FIG. 6. In other words, the two sub-pixels have different electrode patterns.

As shown in FIG. 9, the electrode pattern 901 in sub-pixel 1 is formed with two slits. In the sub-pixel 1 area, the majority portions of the two slits are located respectively in the upper-left and lower-right regions of the sub-pixel 1 area. The electrode pattern 903 in sub-pixel 2 is also formed with two slits. In the sub-pixel 2 area, the majority portions of the two slits are located respectively in the upper-right and lower-left regions of the sub-pixel 2 area.

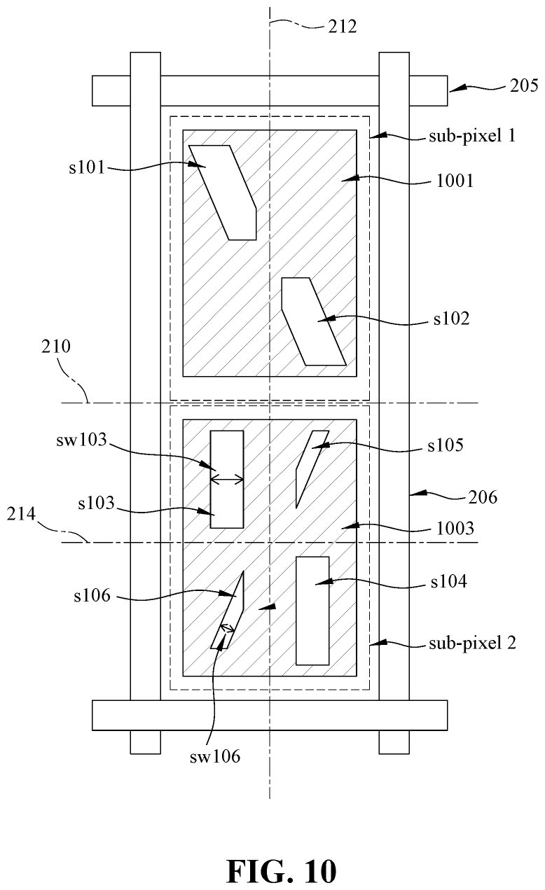

FIG. 10 shows a further variation of the self-compensated electrode patterns in a pixel area of an LCD device according to the present invention. In this example, each pixel area also comprises sub-pixel 1 and sub-pixel 2. Sub-pixel 1 is formed with a self-compensated electrode pattern 1001 similar to the one shown in FIG. 7. Sub-pixel 2 is formed with a self-compensated electrode pattern 1003 having four slits, i.e., slit s103, s104, s105 and s106, by removing four selected regions of the electrode layer respectively in upper-left, lower-right, upper-right and lower-left regions of the sub-pixel 2 area.

As shown in FIG. 10, the electrode pattern 1003 in sub-pixel 2 is neither left-right symmetric with respect to the vertical reference line 212 nor top-down symmetric with respect to the horizontal reference line 214. The horizontal reference line 214 passing through the center of the sub-pixel 2 area is parallel to the gate line 205. The majority portions of slit s103 and slit s104 are located respectively in the upper-left and lower-right regions of the sub-pixel 2 area, and the majority portions of slit s105 and slit s106 are located respectively in the upper-right and lower-left regions of the sub-pixel 2 area.

The longitudinal direction of slit s103 and data line 206 has an angle between 0 to 10 degrees. Preferably, the angle is 0 degree. The longitudinal direction of slit s104 and data line 206 also has an angle between 0 to 10 degrees, and preferably 0 degree. It is preferred but not necessary that the two angles are the same.

As shown in FIG. 10, the longitudinal direction of slit s105 and data line 206 has an angle between 15 to 30 degrees. Preferably, the angle is between 20 to 26 degrees. The longitudinal direction of slit s106 and data line 206 also has an angle between 15 to 30 degrees, and preferably between 20 to 26 degrees. It is also preferred but not necessary that the two angles are the same. Furthermore, the width sw103 of slit s103 is preferably not identical to the width sw106 of slit s106. The width of the slit shown in FIG. 10 is uniform. But, it is not necessary. The width of the slit may also be non-uniform with slit width getting narrower in area closer to the center of the sub-pixel.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An LCD device having a plurality of pixel areas, each pixel area having at least one sub-pixel area, the at least one sub-pixel area comprising:
a first substrate formed with a first electrode in the at least one sub-pixel area;
a second substrate formed with a second electrode, the second substrate being opposite to the first substrate; and
a liquid crystal layer with chiral dopants being disposed between the first and second substrates;
wherein at least an even number of slits are formed in the first electrode and the first electrode has an electrode pattern that is neither left-right symmetric nor top-down symmetric.

2. The LCD device as claimed in claim 1, wherein each slit has a longitudinal direction having an angle between 0 to 10 degrees with respect to a data line in the pixel area.

3. The LCD device as claimed in claim 1, wherein each slit is parallel to a data line in the pixel area.

4. The LCD device as claimed in claim 1, wherein each slit has a longitudinal direction having an angle between 15 to 30 degrees with respect to a data line in the pixel area.

5. The LCD device as claimed in claim 1, wherein the slits are aligned on a same line.

6. The LCD device as claimed in claim 1, wherein the slits are not aligned on a same line.

7. The LCD device as claimed in claim 1, wherein only two slits are formed in the first electrode of the at least one sub-pixel area.

8. The LCD device as claimed in claim 7, wherein one of the two slits has a majority portion located in an upper-right region of the at least one sub-pixel area and the other of the two slits has a majority portion located in a lower-left region of the at least one sub-pixel area.

9. The LCD device as claimed in claim 7, wherein one of the two slits has a majority portion located in an upper-left region of the at least one sub-pixel area and the other of the two slits has a majority portion located in a lower-right region of the at least one sub-pixel area.

10. An LCD device having a plurality of pixel areas, each pixel area having at least two sub-pixel areas and comprising:
a first substrate formed with a first electrode layer;
a second substrate formed with a second electrode layer, the second substrate being opposite to the first substrate;
a liquid crystal layer with chiral dopants being disposed between the first and second substrates;
a first sub-pixel area having a first electrode pattern with at least an even number of slits formed in the first electrode layer and the first electrode pattern is neither left-right symmetric nor top-down symmetric; and
a second sub-pixel area having a second electrode pattern with at least an even number of slits formed in the first electrode layer and the second electrode pattern is neither left-right symmetric nor top-down symmetric.

11. The LCD device as claimed in claim 10, wherein each slit has a longitudinal direction having an angle between 0 to 10 degrees with respect to a data line in the pixel area.

12. The LCD device as claimed in claim 10, wherein each slit has a longitudinal direction having an angle between 15 to 30 degrees with respect to a data line in the pixel area.

13. The LCD device as claimed in claim 10, wherein each slit is parallel to a data line in the pixel area.

14. The LCD device as claimed in claim 10, wherein the first electrode pattern has at least two slits located respectively in an upper-left region and a lower-right region of the first electrode pattern, and the second electrode pattern has at least two slits located respectively in an upper-left region and a lower-right region of the second electrode pattern.

15. The LCD device as claimed in claim 10, wherein the first electrode pattern has at least two slits located respectively in an upper-left region and a lower-right region of the first electrode pattern, and the second electrode pattern has at least two slits located respectively in an upper-right region and a lower-left region of the second electrode pattern.

16. The LCD device as claimed in claim 15, wherein the second electrode pattern further has at least two slits located respectively in an upper-left region and a lower-right region of the second electrode pattern and each of the at least two slits located in the upper-left and lower-right regions of the second electrode pattern has a width different from the widths of the at least two slits located in the upper-right and lower-left regions of the second electrode pattern.
